(19) United States
(12) Patent Application Publication
(10) Pub. No.: US 2020/0026362 A1
(43) Pub. Date: Jan. 23, 2020

(54) AUGMENTED REALITY DEVICE AND GESTURE RECOGNITION CALIBRATION METHOD THEREOF

(71) Applicant: LG ELECTRONICS INC., Seoul (KR)

(72) Inventors: Sungjin KIM, Seoul (KR); Beomoh KIM, Seoul (KR); Younghyeog JEON, Seoul (KR)

(73) Assignee: LG ELECTRONICS INC., Seoul (KR)

(21) Appl. No.: 16/588,816

(22) Filed: Sep. 30, 2019

(30) Foreign Application Priority Data
Aug. 30, 2019 (KR) 10-2019-0107796

(51) Int. Cl. G06F 3/01; G06T 7/70

(52) U.S. Cl. CPC G06F 3/017; G06T 2207/30201; G06F 3/013; G06T 7/70

(57) ABSTRACT

Disclosed are an augmented reality device and a gesture recognition calibration method thereof. The gesture recognition calibration method of the augmented reality device according to an embodiment of the present disclosure has the effect in that it is possible to perform more effective gesture recognition by determining the main eyesight of a user by calculating scores using coordinate systems. An AR device of the present disclosure may be associated with an artificial intelligence module, a drone ((Unmanned Aerial Vehicle, UAV), a robot, a VR (Virtual Reality) device, a device associated with 5G services, etc.

Pursuant to 35 U.S.C. § 119(a), this application claims the benefit of earlier filing date and right of priority to Korean Patent Application No. 10-2019-0107796, filed on Aug. 30, 2019, the contents of which are hereby incorporated by reference herein in its entirety.

### BACKGROUND OF THE INVENTION

### Field of the invention

The present disclosure relates to a gesture recognition calibration method and, more particularly, a method and apparatus that recognizes a gesture of a user in consideration of the main visual eyesight of a user and outputs the recognized object in an augmented reality.

### Related Art

An augmented reality (AR) is a technology that overlaps and shows a virtual object on a real image or background. Unlike the virtual reality (VR) in which all of an object, a background, and an environment are made of virtual images, the augmented reality technology enables users to be provided with more real additional information in a real environment by mixing virtual objects with the real environment. For example when a user walking on the street directs a camera of a digital device to the circumference, the user can be provided with information of building, roads, etc. together included in images collected in the camera. Such augmented reality technology is recently further spotlighted with increasing spread of portable devices.

In order to increase portability and convenience of augmented reality electronic devices, a method that can easily control a user interface (UI) should accompany.

For example, in order to control UIs of augmented reality electronic devices of the related art, it is required to learn a new control method or many cases are not intuitive.

Alternatively, the character that simultaneously display a rear object in the reality and a virtual object is not reflected, convenience in UI control is caused in some cases. In particular, when a real object and a virtual object overlap, a user has difficulty in selecting a specific object in some cases.

### SUMMARY OF THE INVENTION

An object of the present disclosure is to solve the problems described above.

Further, the present disclosure provides a method for calibrating an object according to a user's gesture in consideration of main eyesight.

Further, the present disclosure provides a method of determining main eyesight of a user by repeatedly learning a user's gesture and an object designated in accordance with the gesture.

A gesture recognition calibration method according to an embodiment of the present disclosure includes: estimating a position that is indicated by a first indicative gesture of a user; determining, when a first object exists at the position, whether the object exists at a position estimated using a left coordinate system or exists at a position estimated using a right coordinate system; calculating each score by adding a score related to a left eye of the user when the left coordinate system is used, as the result of determination, and by adding a score related to a right eye of the user when the right coordinate system is used; and determining main eyesight of the user by comparing the calculated scores, in which the left coordinate system may be a coordinate system related to a gaze by the left eye of the user and the right coordinate system may be a coordinate system related to gaze by the right eye of the user.

The main eyesight of the user may be determined as the left eye of the user when the score related to the left eye of the user is higher than the score related to the right eye of the user, and the main eyesight of the user may be determined as the right eye of the user when the score related to the left eye of the user is lower than the score related to the right eye of the user.

The method further includes: sensing a second object existing at a position that is indicated by a second indicative gesture of the user on the basis of the main eyesight; and outputting information about the second object through an AR device, in which the information about the second object may be output in the form of an augmented reality.

The AR device may be any one of AR glasses and an AR mobile terminal.

The estimating may be: detecting a fingertip of the user according to the first indicative gesture; and extracting 3D coordinates corresponding to the fingertip of the user and estimating the position using the 3D coordinates.

The first indicative gesture may be recognized through a camera, and the 3D coordinates may be determined using a coordinate system of the camera, the left coordinate system, and the right coordinate system.

The 3D coordinates may be determined using distances and angles between the camera and, the left eye of the user and the right eye of the user.

An augmented reality device includes: an RF (Radio Frequency) module for transmitting and receiving wireless signals; and a processor functionally connected with the RF module, in which the processor estimates a position that is indicated by a first indicative gesture of a user; determines, when a first object exists at the position, whether the object exists at a position estimated using a left coordinate system or exists at a position estimated using a right coordinate system; calculates each score by adding a score related to a left eye of the user when the left coordinate system is used, as the result of determination, and by adding a score related to a right eye of the user when the right coordinate system is used; and determines main eyesight of the user by comparing the calculated scores, in which the left coordinate system may be a coordinate system related to a gaze by the left eye of the user, and the right coordinate system may be a coordinate system related to gaze by the right eye of the user.

The main eyesight of the user may be determined as the left eye of the user when the score related to the left eye of the user is higher than the score related to the right eye of the user, and the main eyesight of the user may be determined as the right eye of the user when the score related to the left eye of the user is lower than the score related to the right eye of the user.

Wherein the processor may sense a second object existing at a position that is indicated by a second indicative gesture of the user on the basis of the main eyesight, and may output information about the second object, and the information about the second object may be output in the form of an augmented reality.

The AR device may be any one of AR glasses and an AR mobile terminal.

The processor may detect a fingertip of the user according to the first indicative gesture, extract 3D coordinates corresponding to the fingertip of the user, and estimate the position using the 3D coordinates.

The first indicative gesture may be recognized through a camera, and the 3D coordinates may be determined using a coordinate system of the camera, the left coordinate system, and the right coordinate system.

The 3D coordinates may be determined using distances and angles between the camera and, the left eye of the user and the right eye of the user.

An electronic device includes: one or more processors; a memory; and one or more programs, in which the one or more programs may be stored in the memory, may be configured to be executed by the one or more processors, and may include commands for performing the gesture recognition calibration method.

### BRIEF DESCRIPTION OF THE DRAWINGS

Accompanying drawings included as a part of the detailed description for helping understand the present disclosure provide embodiments of the present disclosure and are provided to describe technical features of the present disclosure with the detailed description.

FIG. 1 is a block diagram illustrating a wireless communication system to which methods proposed herein may apply;

FIG. 2 is a view illustrating an example signal transmission/reception method in a wireless communication system;

FIG. 3 is a view illustrating basic example operations of a user terminal and a 5G network in a 5G communication system;

FIG. 4 is a perspective view of an augmented reality electronic device according to an embodiment of the present disclosure.

FIG. 5 is a diagram showing the configuration of the augmented reality electronic device according to an embodiment of the present disclosure.

FIG. 6 is a block diagram illustrating an AI device according to an embodiment of the present invention;

FIG. 7 is a flowchart showing a method of determining main eyesight proposed in the present specification.

FIG. 8 is a flowchart showing a method of recognizing an indicative gesture proposed in the present specification.

FIG. 9 is a diagram showing an example of the method of determining main eyesight proposed in the present specification.

FIG. 10 is a diagram in which object information is output as an augmented reality in consideration of main eyesight of a user.

FIG. 11 is a diagram showing another example of determining main eyesight of a user.

FIG. 12 is another flowchart showing the method of determining main eyesight of a user.

FIG. 13 is a diagram showing an example of a method of checking a cleaning section of a cleaning robot based on an indicative gesture and a voice instruction.

FIG. 14 is a flowchart showing the method of checking a cleaning section of a cleaning robot based on an indicative gesture and a voice instruction.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

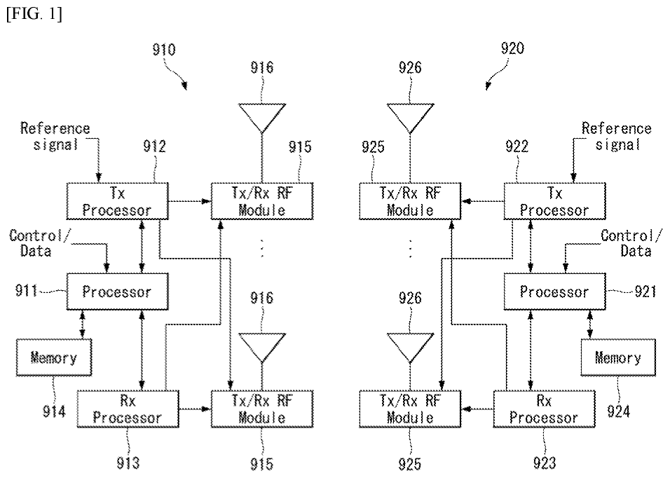

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

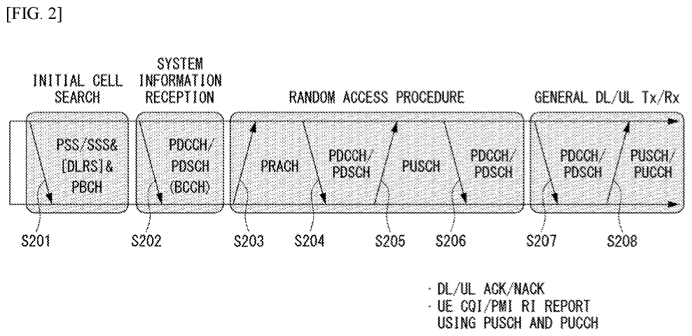

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

[symbol]

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

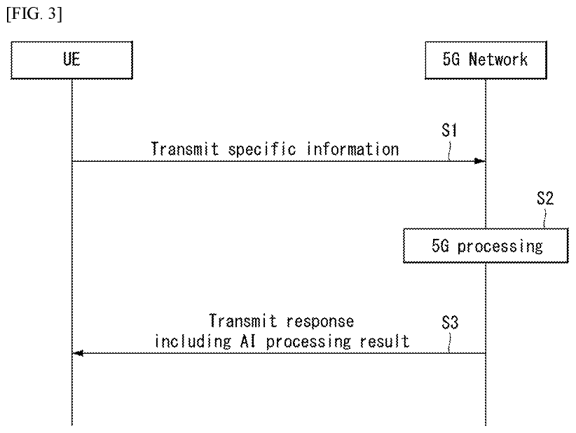

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

Augmented Reality Electronic Device

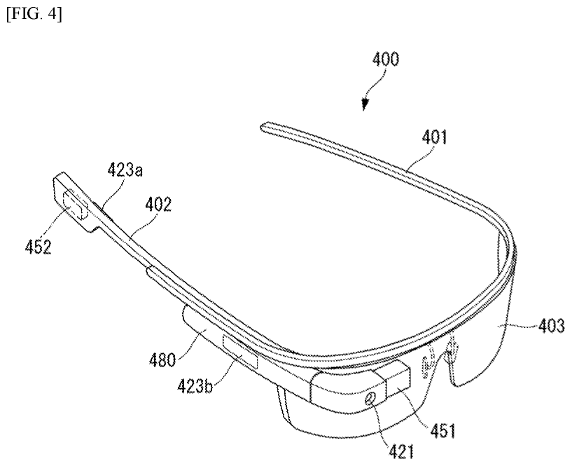

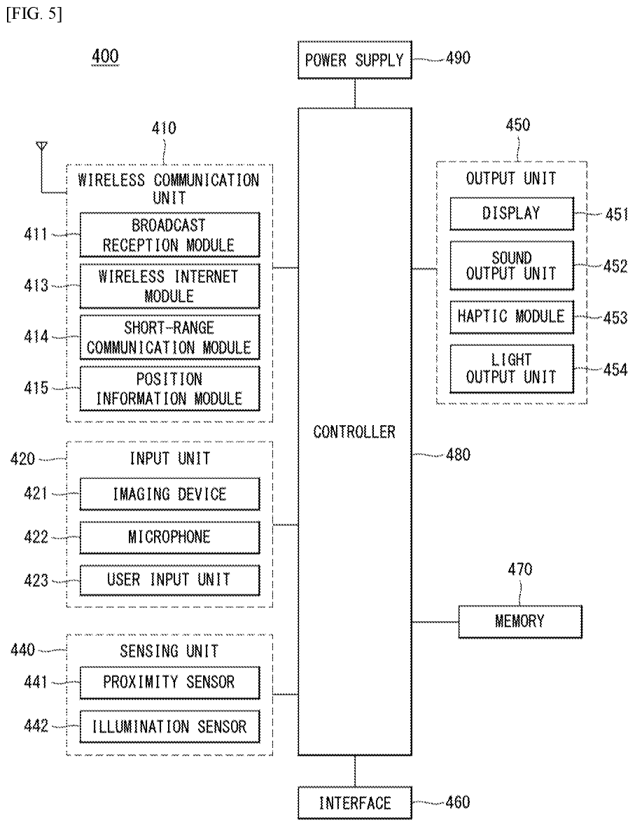

FIG. 4 is a perspective view of an augmented reality electronic device according to an embodiment of the present disclosure. FIG. 5 is a diagram showing the configuration of the augmented reality electronic device according to an embodiment of the present disclosure.

Referring to FIG. 4, a glasses type mobile terminal 400 is configured to be able to be worn on the head of a human body and may have a frame unit (a case, a housing, etc.) for this purpose. The frame unit may be made of a flexible material for easy wearing. In the figure, the frame unit is exemplified as including a first frame 401 and a second frame 402 that are made of different materials.

The frame unit is supported on a head and has spaces in which various parts are mounted. As shown in the figure, electronic devices such as a controller 480 and a sound output unit 452 can be mounted in the frame unit. Further, a lens 403 that covers at least one of a left eye and a right eye may be detachably mounted on the frame unit.

The controller 480 is configured to control various electronic devices of the mobile terminal 400. In the figure, it is exemplified that the controller 480 is installed on the frame unit on a side of a head. However, the position of the controller 480 is not limited thereto.

A display 451 may be implemented in the type of a head mount display (HMD). The HMD means a display method in which a display is mounted on a head and directly shows an image in front of user's eyes. When a user wears the glasses type mobile terminal 400, in order to be able to directly show an image in front of the user's eyes, the display 451 may be disposed to correspond to at least one of the left eye and the right eye. In the figure, it is exemplified that the display 451 is positioned at a portion corresponding to a user's right eye to be able to output an image toward the right eye.

The display 451 can project an image to a display area using a prism. Further, the prism may be formed in a light transmission type so that a user can see both of a projected image and a common forward visual field (a range that the user can visually see).

As described above, an image output through the display 451 can be overlapped and shown with the common visual field. The mobile terminal 400 can provide an augmented reality (AR) that shows a virtual image overlapping a real image or background as one image using the above characteristic of the display.

An image device 421 is disposed adjacent to at least one of the left eye and the right eye to take images of the front area. Since the imaging device 421 is positioned close to the eye, the imaging device 421 can the scene, which the user sees, as an image.

In the figure, it is exemplified that the imaging device 421 is disposed in a control module 480, but is not necessarily limited thereto. The imaging device 421 may be installed in the frame unit and may be provided as a plurality of pieces to acquire 3D images.

The glasses type mobile terminal 400 may include user input units 423a and 423b that are operated to receive input of control instructions. The user input units 423a and 423b may employ any manner such as touch and push as long as it is a tactile manner in which a user operates them while having a tactile feeling. In the figure, it is exemplified that push type and touch input type user input units 423a and 423b are disposed at the frame unit and the control module 480, respectively.

Further, the glasses type mobile terminal 400 may include a microphone that receives input of a sound and processes it into electrical voice data, and a sound output unit 452 that outputs a sound. The sound output unit 452 may be configured to transmit sounds through a common sound output type or a bone conduction type. When the sound output unit 452 is implemented in the bone conduction type and a user wears the mobile terminal 400, the sound output unit 452 is in close contact with the head and transmits a sound by vibrating the skull.

Referring to FIG. 5, an augmented reality electronic device 400 may include a wireless communication unit 410, an input unit 420, a sensing unit 440, an output unit 450, an interface 460, a memory 470, a controller 480, a power supply 490, etc. The components shown in FIG. 1a are not necessary in implementing a mobile terminal, so the mobile terminal described in the present specification may include components more than or less than the components described above.

In more detail, in the components, the wireless communication unit 410 may include one or more modules that enable wireless communication between the augmented reality electronic device 400 and a wireless communication system, between the augmented reality electronic device 400 and another augmented reality electronic device 400, or between the augmented reality electronic device 400 and an external server. Further, the wireless communication unit 410 may include one or more modules that connect the augmented reality electronic device 400 to one or more networks.

The wireless communication unit 410 may include at least one of a broadcasting reception module 411, a mobile communication module 412, a wireless interne module 413, a short-range communication module 414, and a position information module 415.

The input unit 420 may include a camera 421 or an image input unit for inputting image signals, a microphone 422 or an audio input unit for receiving input of audio information from a user, and a user input unit 423 (e.g., a touch key and a mechanical key) for receiving input of information from a user. Voice data or image data collected by the input unit 420 can be analyzed and processed as control instructions of a user.

The sensing unit 440 may include at least one or more sensors for sensing at least one of information in a mobile terminal, surrounding environment information around the mobile terminal, and user information. For example, the sensing unit 440 may include at least one of a proximity sensor 441, an illumination sensor 442, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., the imaging device (see 421)), a microphone (see 422), a battery gauge, an environmental sensor (e.g., a barometer, a hygrometer, a thermometer, a radioactivity sensor, a thermal sensor, and a gas sensor), and a chemical sensor (e.g., an electronic nose, a healthcare sensor, and a biological sensor). Meanwhile, the mobile terminal disclosed in the present specification may use combinations of items of information sensed by at least two or more sensors these sensors.

The output unit 450, which is for generating output related to the sense of sight, the sense of hearing, or the sense of touch, may include at least one of the display 451, the sound output unit 452, a haptic module 453, and a light output unit 454. The display 451 forms a mutual layer structure with the touch sensor or is formed integrally with the touch sensor, thereby being able to implement a touch screen. Such a touch screen can function as a user input unit 423 that provides an input interface between the augmented reality electronic device 400 and a user, and can provide an output interface between the augmented reality electronic device 400 and the user.

The interface 460 performs a passage function with various kinds of external devices connected to the augmented reality electronic device 400. The interface 460 may include at least one of a wire/wireless headset port, an external charger port, a wire/wireless data port, a memory card port, a port connecting a device equipped with an identification module, an audio I/O (Input/Output) port, a video I/O (Input/Output) port, and an earphone port. In the augmented reality electronic device 400, in correspondence to connection of an external device to the interface 460, it is possible to perform appropriate control related to the connected external device.

Further, the memory 470 stores data that support various functions of the augmented reality electronic device 400. The memory 470 can store several application programs (or applications) that are driven in the augmented reality electronic device 400, and data and commands for the operation of the augmented reality electronic device 400. At least some of the application programs can be downloaded from an external server through wireless communication. Further, at least some of the application programs may exist in the augmented reality electronic device 400 from the time of delivery from a warehouse for the fundamental functions (e.g., a function of answering and making a phone call and a function of receiving and transmitting a message) of the augmented reality electronic device 400. Meanwhile, the application programs may be stored in the memory 470, installed in the augmented reality electronic device 400, and driven to perform the operation (or function) of the mobile terminal by the controller 480.

The controller 480 generally controls the general operations of the augmented reality electronic device 400 other than the operations related to the application programs. The controller 480 processes signals, data, information, etc. that are input or output through the components described above, or drives the application programs stored in the memory 470, thereby being able to provide or process appropriate information or functions to a user.

Further, the controller 480, in order to drive the application programs stored in the memory 470, can control at least some of the components described with reference to FIG. 1a. Further, the controller 480, in order to drive the application programs, can combine and operate at least two or more of the components included in the augmented reality electronic device 400.

The power supply 490 receives external power and internal power and supplies power to the components included in the augmented reality electronic device 400 under control by the controller 480. The power supply 490 includes a battery and the battery may be a built-in type battery or a replaceable type battery.

At least some of the components can operate in cooperation with each other to implement the operation, control, or control method of the mobile terminal according to various embodiments to be described below. Further, the operation, control, or control method of the mobile terminal may be implemented in the mobile terminal by driving at least one application programs stored in the memory 470.

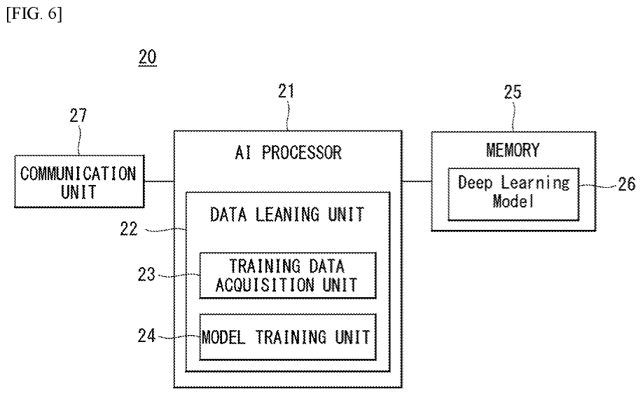

FIG. 6 is a block diagram of an AI device according to an embodiment of the present disclosure.

Referring to FIG. 6, an AI device 20 may include an electronic device including an AI module that can perform AI processing, a server including the AI module, or the like. Further, the AI device 20 may be included as at least one component of the augmented reality electronic device 400 shown in FIG. 4 to perform together at least a portion of the AI processing.

The AI processing may include all operations related to control of the augmented reality electronic device 400 shown in FIG. 4. For example, the augmented reality electronic device 400 can perform operations of processing/determining, and control signal generating by performing AI processing on sensing data or acquired data. Further, for example, the augmented reality electronic device 400 can perform control of an intelligent electronic device by performing AI processing on data received through a communication unit.

The AI device 20 may be a client device that directly uses an AI processing result or a device in a cloud environment that provides an AI processing result to another device.

The AI device 20 may include an AI processor 21, a memory 25, and/or a communication unit 27.

The AI device 20, which is a computing device that can train a neural network, may be implemented as various electronic devices such as a server, a desktop PC, a notebook PC, and a tablet PC.

The AI processor 21 can learn a neural network using programs stored in the memory 25. In particular, the AI processor 21 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks(CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence learning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and by applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the data leaning unit 22 is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural network model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without supervision. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessor. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs control related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

A method of indicating a specific object using an indicative gesture and outputs information about the specific object to an augmented reality through an artificial intelligence device (e.g., AR glasses) in the related art had a problem in that the accuracy of an object that is indicated on the basis of an indicative gesture is deteriorated because the main eyesight of a user is not considered.

That is, there is a problem in that an object that a user indicates is accurately the object according to the real intention of the user.

For example, there was a case in which when a plurality of objects is positioned close to each other, an object that a user indicated and an object that an artificial intelligence device indicated were different.

Accordingly, the present specification, in order to solve these problems, proposes a method of increasing accuracy about an object that a user indicates in consideration of the main eyesight of the user.

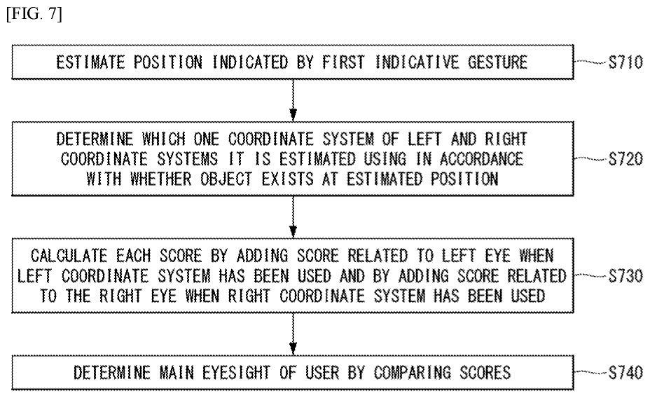

FIG. 7 is a flowchart showing a method of determining main eyesight proposed in this specification.

First, a position that is indicated by a first indicative gesture of a user is estimated (S710).

Next, when a first object exists at the position, it is determined whether the object exists at a position estimated using a left coordinate system or exists at a position estimated using a right coordinate system (S720).

As the result of determination, when the left coordinate system has been used, a score related to the left eye of the user is added, and when the right coordinate system has been used, a score related to the right eye of the user is added, thereby calculating each point (S730).

Main eyesight of the user is determined by comparing the calculated scores (S740).

In this case, the left coordinate system may be a coordinate system related to the gaze by the left eye of the user and the right coordinate system may be a coordinate system related to the gaze by the right eye of the user.

The main eyesight of the user may be determined as the left eye of the user when the score related to the left eye of the user is higher than the score related to the right eye of the user. Further, the main eyesight of the user may be determined as the right eye of the user when the score related to the left eye of the user is lower than the score related to the right eye of the user.

Further, on the basis of the main eyesight, it is possible to sense a second object that exists at a position that is indicted by a second indicative gesture of the user and to output information about the second object through an AR device.

In this case, the information about the second object may be output in the form of an augmented reality.

In this case, the AR device may be any one of AR glasses and an AR mobile terminal.

The step S710 may be detecting a fingertip of the user according to the first indicative gesture, extracting 3D coordinates corresponding to the fingertip of the user, and estimating the position using the 3D coordinates.

In this case, the first indicative gesture may be recognized through a camera, and the 3D coordinates may be determined using a coordinate system of the camera, the left coordinate system, and the right coordinate system.

Further, the 3D coordinates may be determined using distances and angles between the camera and, the left eye of the user and the right eye of the user.

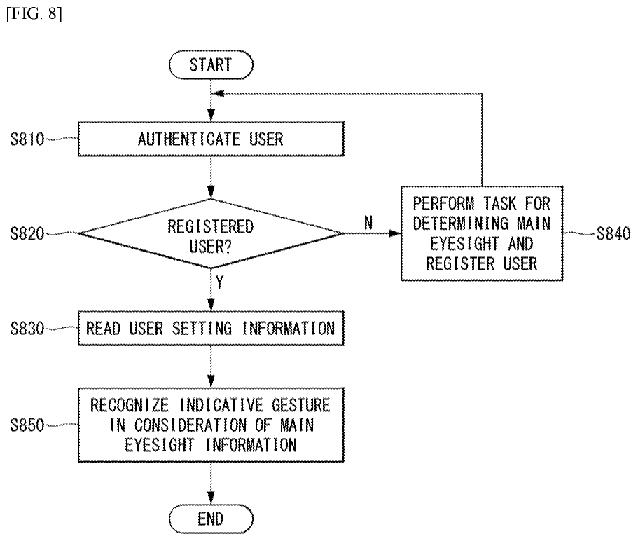

FIG. 8 is a flowchart showing a method of recognizing an indicative gesture proposed in the present specification.

First, the AR device can authenticate a user through an authentication device included in the AR device. In this case, the authentication device may be a camera, a fingerprint recognizer, or the like, and when a camera is used, it is possible to recognize a user using the iris of the user, and when a fingerprint recognizer is used, it is possible to recognize a user using the fingerprints of the user (S810).

Thereafter, the AR device determines whether the user is a registered user through the recognition result of S810 (S820).

As the result of determination in step S820, when the user is not a registered user, a task for determining main eyesight is performed and the user is registered on the AR Device (S840). Thereafter, step S810 can be performed again.

As the result of determination in step S820, when the user is a registered user, setting information of the user is called up. In this case, the main eyesight of the user may be included in the setting information (S830).

Thereafter, the AR device recognizes an indicative gesture of the user in consideration of main eyesight information of the user (S850).

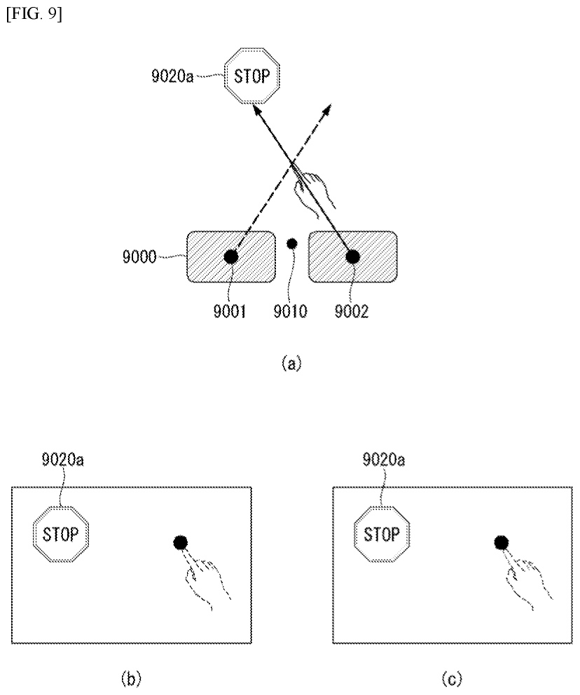

FIG. 9 is a diagram showing an example of the method of determining main eyesight proposed in the present specification.

Hereafter, the method of determining main eyesight is described using FIG. 9.

First, a user can wear a device that can recognize indicative gestures of the user. In this case, the device may be AR glasses 9000, an AR mobile terminal, an artificial intelligence device, or the like. Hereafter, the device is described on the basis of the AR glasses 9000, but is not limited thereto.

In this case, the AR glasses 9000 may include a camera 9010 that can recognize indicative gestures of the user. The indicative gesture may mean a motion that indicates a specific object using fingers.

FIG. 9a shows a diagram in which main eyesight of a user is checked using an object that an indicative gesture of the user indicates.

Referring to FIG. 9a, the AR glasses 9000 can determine whether a specific object 9020a indicated by a fingertip of a user is on an extension line of the gaze of a left eye 9001 of the user or is on an extension line of the gaze of a right eye 9002 of the user.

In FIG. 9a, the dotted-line arrow indicates the gaze of the left eye 9001 of the user and the solid-line arrow indicates the gaze of the right eye 9002 of the user.

In FIG. 9a, the specific object 9020a indicated by the user is on the extension line of the gaze of the right eye 9002. In this case, the AR device can determine that the main eyesight of the user is the right eye.

Further, the AR device can increase accuracy in determining the main eyesight of the user by repeatedly performing this main eyesight determination process, in which deep learning may be used.

FIGS. 9b and 9c are diagrams showing positions that are indicated by indicative gestures of a user according to the main eyesight of the user.

The point in FIG. 9b indicates the position that the fingertip of the user indicates. In this case, the position of the point was determined in consideration of the gaze of the left eye of the user and it can be seen the position does not coincide with the position of the specific object 9020a. In this case, it is possible to determine that the main eyesight of the user is not the left eye.

In the case of FIG. 9c, the gaze of the right eye of the user is shown through a point, and in this case, it can be seen that the point is at the same position as the specific object 9020a. That is, in this case, it is possible to determine that the main eyesight of the user is the right eye.

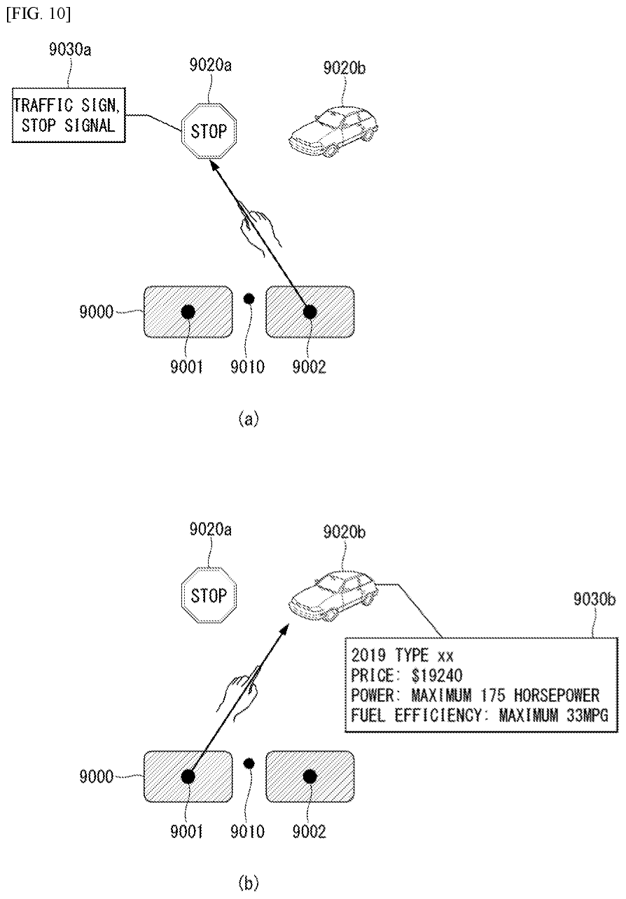

FIG. 10 is a diagram in which object information is output as an augmented reality in consideration of main eyesight of a user.

Referring to FIG. 10a, the AR glasses 9000 can determine an object 9020a indicated by the fingertip of the user of a plurality of objects 9020a and 9020b in consideration of the main eyesight of the user. In FIG. 10a, the right eye 9002 of the user is the main eyesight, so the AR glasses 9000 can output detailed information of the object 9020a indicated by the fingertip in the form of an augmented reality.

In FIG. 10a, the object 9020a indicated by the fingertip is a traffic signal showing ‘stop’ and ‘traffic sign, stop signal’ that is information about the object can be output as an augmented reality through the AR glasses 9000.

FIG. 10b is a diagram in which when the left eye of the user is the main eyesight, information about an object is output in the form of an augmented reality.

In FIG. 10b, the main eyesight is the left eye of the user, and accordingly, it is possible to output information 9030b about the object 9020b indicated by an indicative gesture of the user in the form of an augmented reality. In this case, the object 9020b is a vehicle, and the product name of the vehicle, the output (horsepower) of the vehicle, the fuel efficiency (MPG) of the vehicle, etc. may be included in the relevant information 9030b.

As can be seen in FIG. 10, when a plurality of objects exists close to each other, there is a problem in that an object indicated by an indicative gesture of the user is not accurately determined, but, by considering the main eyesight of the user, there is an effect in that it is possible to accurately determine the object indicated by the user.

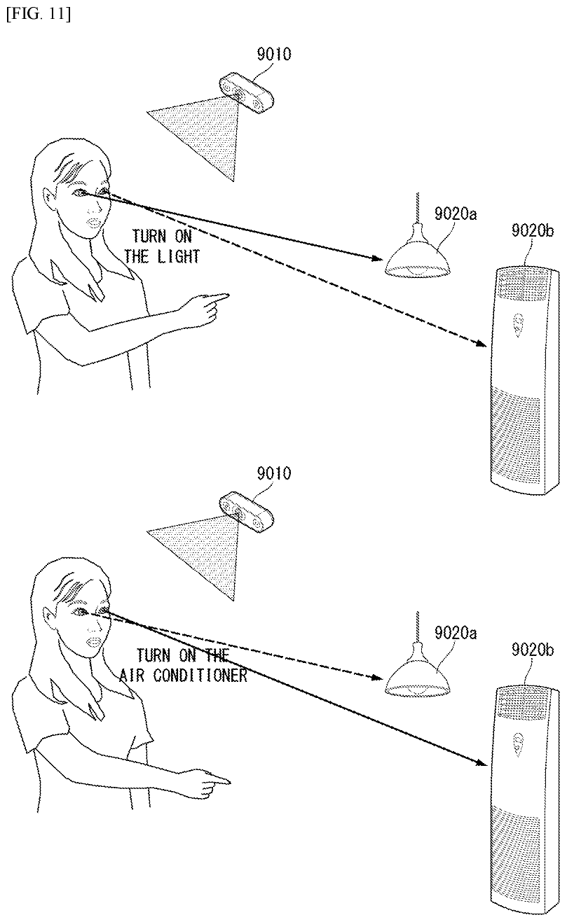

FIG. 11 is a diagram showing another example of determining main eyesight of a user.

That is, FIG. 11 is a diagram showing a method of checking an object indicated by an indicative gesture of a user on the basis of a user's voice instruction and correspondingly determining the main eyesight of the user.

Referring to FIG. 11, the camera 9010 can sense an object that is indicated by an indicative gesture of the user of a plurality of objects. In FIG. 11, the solid-line arrow shows the gaze of the eye of the main eyesight of the user and the dotted-line arrow shows the gaze of the eye that is not the main eyesight of the user.

A plurality of objects may exist close to each other, and referring to FIG. 11, for example, a light 9020a and an air conditioner 9020b may exist close to each other.

Referring to FIG. 11, it is possible to determine an object indicated by the user by simultaneously recognizing an indicative gesture of the user and a voice instruction of the user. For example, when a user takes an indicative gesture simultaneously with a voice instruction “turn on the light”, the camera 9010 can recognize that the user has indicted the light of the light 9020a and the air conditioner 9020b and can determine that the main eyesight of the user is the right eye. As another example, when a user takes an indicative gesture simultaneously with a voice instruction “turn on the air conditioner”, the camera 9010 can recognize that the user has indicted the air conditioner of the light 9020a and the air conditioner 9020b and can determine that the main eyesight of the user is the left eye.

In this case, in order to determine an indicated object in accordance with the gaze of the right eye and the left eye of the user, the fingertip of the user and the eyes are respectively connected through a straight line and the object on the straight extension line is determined as the object indicated by the user.

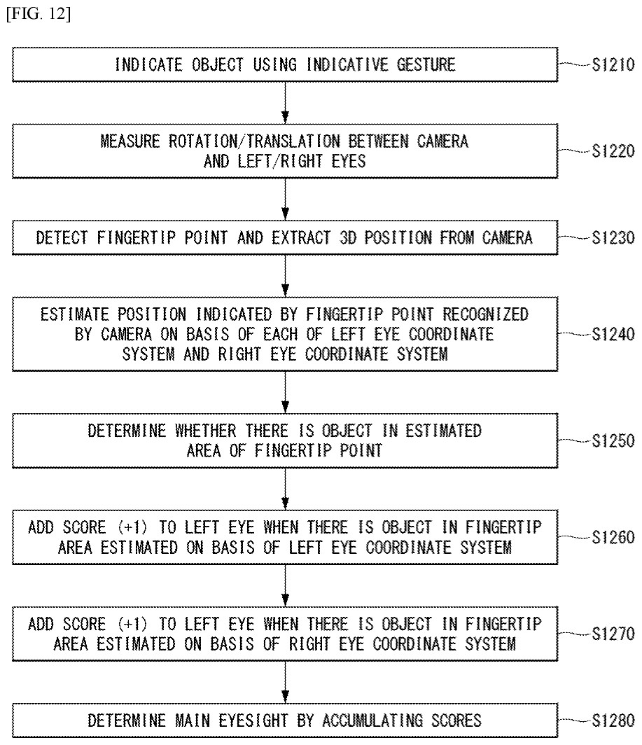

FIG. 12 is another flowchart showing the method of determining main eyesight of a user.

That is, FIG. 12 is a flowchart showing a method of automatically calibrating the main eyesight of a user.

First, it is assumed that a user wears AR glasses equipped with a cameral.

The user indicates an object through an indicative gesture (S1210).

Further, the AR glasses measure the rotation and the translation between the camera and each of the left eye and the right eye.

The camera detects a fingertip point and extracts the 3D position of the fingertip point (S1230). In this case, the 3D position can be extracted in the form of coordinates, and to this end, a camera coordinate system, a left eye coordinate system, and a right eye coordinate system can be used.

Further, the AR glasses estimate the position indicted by the fingertip point recognized by the camera on the basis of the left eye coordinate system and the right eye coordinate system (S1240). That is, the point of one fingertip point based on the left eye is estimated on the basis of the left eye coordinate system and the point of one fingertip point based on the right eye is estimated on the basis of the right eye coordinate system.

Whether an object exists in the area of the fingertip points estimated in step S1240 is determined (S1250).

As the result of determination in S1250, when an object exists in the area of the fingertip point estimated on the basis of the left eye coordinate system, a score is added to the left eye, and when an object exists in the area of the fingertip point estimated on the basis of the right eye coordinate system, a score is deducted from the left eye (S1260 and S1270). Deducting a score from the left eye may the same meaning as adding a score to the right eye.

Further, this process can be performed again from step S1210.

Accordingly, deduction of a score and addition of a score can be accumulated, and whether the left eye is the main eyesight or the right is the main eyesight is determined in consideration of these accumulated scores (S1280).

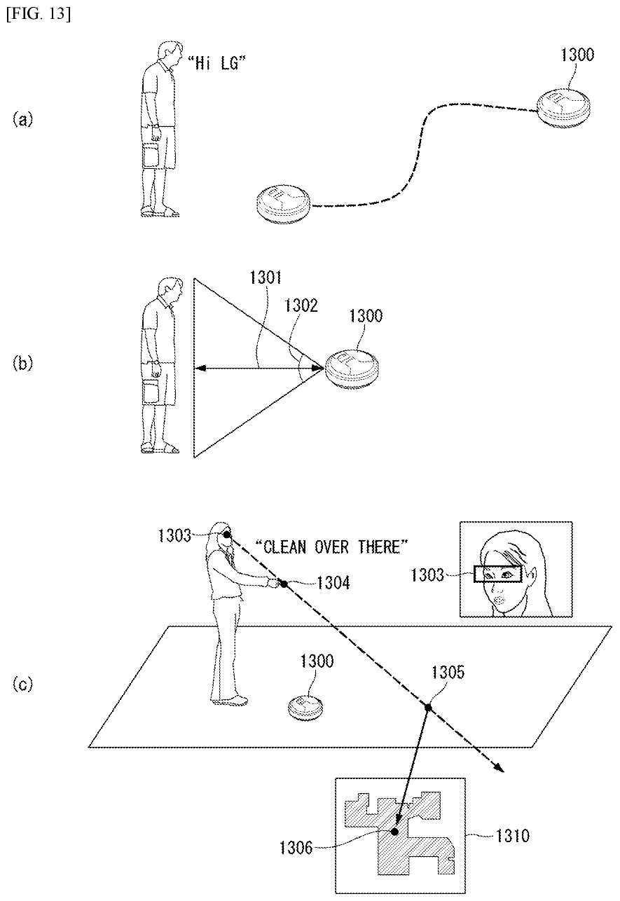

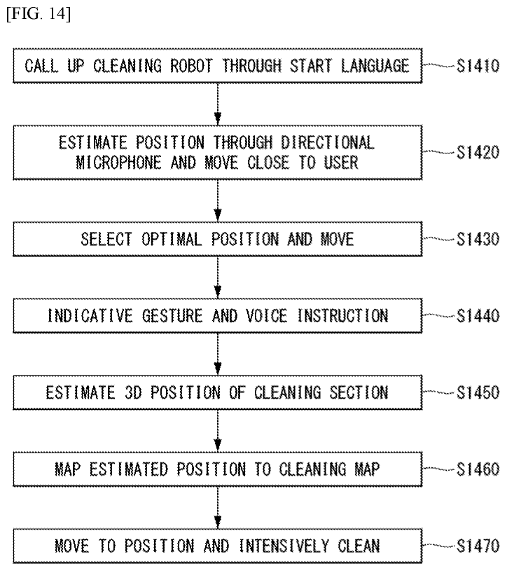

FIG. 13 is a diagram showing an example of a method of checking a cleaning section of a cleaning robot based on an indicative gesture and a voice instruction and FIG. 14 is a flowchart showing the method of checking a cleaning section of a cleaning robot based on an indicative gesture and a voice instruction.

Referring to FIGS. 13 and 14, a user can call up a robot cleaner 1300 using a start language (S1410 in FIG. 13a). The first language, which is for converting the robot cleaner 1300 into a state for recognizing a voice command, may be, for example “Hi LG”.

Next, the robot cleaner 1300 estimates the position of the user using a built-in directional microphone and moves close to the user (S1420 in FIG. 13a).

Thereafter, the robot cleaner 1300 selects an optimal position for receiving a voice command from the user and moves to the position (S1430 in FIG. 13a). In this case, for optimal selection, it is possible to consider the distance 1301 from the user, the size of the user, and the view of angle 1302 of the camera installed in the robot cleaner 1300 (FIG. 13b).

The user can give an instruction for cleaning to the robot cleaner 1300 through an indicative gesture and a voice instruction. For example, the user can give an instruction for a cleaning section through an indicative gesture, and given an instruction for cleaning to the robot cleaner by simultaneously uttering a voice command such as “Clean over there” (S1340 in FIG. 13c).

The robot cleaner 1300 performs 3D position estimation to recognize the cleaning section instructed by the users (S1440 in FIG. 13c). In detail, the robot cleaner 1300 senses the position of the eyes 1303 of the user and the position of a fingertip 1304 by an indicative gesture of the user, connects the two positions, and calculates an intersection of the straight extension line and the ground, thereby being able to recognize the cleaning section. In this case, the two positions may be sensed/recognized in the form of 3D coordinates, and the main eyesight of the user described above may be further considered.

Further, the cleaning section estimated in step S1440 is mapped to a cleaning map 1310 (S1450). In this case, the cleaning map 1310 may correspond to a section set in advance by the user and may be stored in advance in the robot cleaner 1300.

Thereafter, the robot cleaner 1300 moves to the cleaning section and starts cleaning (S1460).

Further, for sensing/recognizing in the form of 3D coordinate system, imaging geometry can be used.

Imaging geometry refers to transformation from a world coordinate system to a camera coordinate system.

The world coordinate system means a coordinate system that is taken as a reference when showing the position of an object and the camera coordinate system means a coordinate system based on a camera.

Further, a pixel coordinate system and a regular coordinate system may be additionally used, in which the pixel coordinate system means a coordinate system for an image that a user actually sees and the regular coordinate system means an image coordinate system with influence by internal parameters of a camera removed.

To this end, Euclidean transformation (rigid motion of a camera) may be used and is as the following Formula 1.

X_{c}=RX_{w}+T [Formula 1]

Xc is a camera coordinate system and X2 is a world coordinate system.

Further, imaging geometry, the following Formula 2 may be used.

$$x = [ \begin{matrix}u \\ v \\ 1\end{matrix} ] = C [ \begin{matrix}1 & 0 & 0 & 0 \\ 0 & 1 & 0 & 0 \\ 0 & 0 & 1 & 0\end{matrix} ] [ \begin{matrix}{R}^{T} & t \\ {0}_{3}^{T} & 1\end{matrix} ] [ \begin{matrix}{X}_{w} \\ {Y}_{w} \\ {Z}_{w} \\ 1\end{matrix} ] \qquad [ Formula 2 ]$$

In Formula 2, u and v are coordinate points in a pixel coordinate system, C is an internal parameter matrix of a camera, the matrix

$$[ \begin{matrix}1 & 0 & 0 & 0 \\ 0 & 1 & 0 & 0 \\ 0 & 0 & 1 & 0\end{matrix} ]$$

is a projection matrix that projects a 3D coordinates in a camera coordinate system to a regular image plane (regular coordinate system), and the matrix

$$[ \begin{matrix}{R}^{T} & t \\ {0}_{3}^{T} & 1\end{matrix} ]$$

is a rigid transformation matrix that transforms the world coordinate system into the camera coordinate system.

Formula 2 can be briefly expressed as Formula 3 through P matrix.

The P matrix is a 3×4 projection matrix from a 3D space to an image and is as the following Formula 4.

$$\begin{matrix}x = P [ \begin{matrix}X \\ 1\end{matrix} ] & [ Formula 3 ] \\ P = C [ R \vert T ] & [ Formula 4 ]\end{matrix}$$

An AR device to which the method proposed in the present specification is described hereafter.

The AR device may include an RF (Radio Frequency) module for transmitting and receiving wireless signals, and a processor functionally connected with the RF module.

First, the processor can control the RF module to estimate a position that is indicated by a first indicative gesture of a user.

When a first object exists at the position, the processor can control the RF module to determine whether the object exists at a position estimated using a left coordinate system or exists at a position estimated using a right coordinate system.

The processor can control the RF module to calculate each score by adding a score related to the left eye of the user when the left coordinate system has been used, as the result of determination, and by adding a score related to the right eye of the user when the right coordinate system has been used.

The processor can control the RF module to determine the main eyesight of the user by comparing the calculated scores.

In this case, the left coordinate system may be a coordinate system related to the gaze by the left eye of the user and the right coordinate system may be a coordinate system related to the gaze by the right eye of the user.

In this case, the main eyesight of the user may be determined as the left eye of the user when the score related to the left eye of the user is higher than the score related to the right eye of the user. Further, the main eyesight of the user may be determined as the right eye of the user when the score related to the left eye of the user is lower than the score related to the right eye of the user.

The processor can control the RF module to sense a second object that exists at a position that is indicted by a second indicative gesture of the user.

The processor can control the RF module to output information about the second object.

In this case, the information about the second object may be output in the form of an augmented reality.

In this case, the AR device may be any one of AR glasses and an AR mobile terminal.

The processor can control the RF module to detect a fingertip of the user according to the first indicative gesture, extract 3D coordinates corresponding to the fingertip of the user, and estimate the position using the 3D coordinates.

In this case, the first indicative gesture may be recognized through a camera, and the 3D coordinates may be determined using a coordinate system of the camera, the left coordinate system, and the right coordinate system.

The 3D coordinates may be determined using distances and angles between the camera and, the left eye of the user and the right eye of the user.

Meanwhile, there may be an electronic device including commands for performing the gesture recognition calibration method described above.

The electronic device may be configured by including one or more processor, a memory, and one or more programs, in which one or more programs are stored in the memory and configured to be executed by the one or more processors, and may include commands for performing the gesture recognition calibration method described above.

Some embodiments or other embodiments of the present disclosure described above are not exclusive or discriminated from each other. The configurations or functions of some embodiments or other embodiments of the present disclosure described above may be simultaneously used or combined.

For example, it means that the configuration A described in a specific embodiment and/or the drawings and the configuration B described in another embodiment and/or the drawings may be combined. That is, it means that even if combination of configurations is not directly described, combination is possible unless it is described that combination is impossible.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Effects of the gesture recognition calibration method according to an embodiment of the present disclosure are as follows.

The present disclosure can perform more accurate recognition by recognizing a gesture in consideration of the main eyesight of a user.

Further, it is possible to accurately determine an object that a user indicates by providing a method of determining the main eyesight of the user.

The effects of the present disclosure are not limited to the effects described above and other effects can be clearly understood by those skilled in the art from the following description.

What is claimed is:

1. A gesture recognition calibration method of an augmented reality device, the method comprising:
estimating a position of an object that is indicated by a first indicative gesture of a user;
determining whether the estimated position of the object corresponds to a left coordinate system or a right coordinate system;
calculating a score for each of the left coordinate system and the right coordinate system, wherein the score for the left coordinate system is increased when it is determined that the estimated position of the object corresponds to the left coordinate system and the score for the right coordinate system is increased when it is determined that the estimated position of the object corresponds to the right coordinate system; and
determining a main eyesight of the user based on the calculated scores,
wherein the left coordinate system is related to a gaze by the left eye of the user and the right coordinate system is related to gaze by the right eye of the user.

2. The method of claim 1, wherein:
the main eyesight of the user is determined as the left eye of the user when the score for the left coordinate system is greater than the score for the right coordinate system; and
the main eyesight of the user is determined as the right eye of the user when the score for the right coordinate system is greater than the score for the left coordinate system.

3. The method of claim 1, further comprising:
sensing a second object at a position that is indicated by a second indicative gesture of the user based on the main eyesight; and
outputting information about the second object through an augmented reality (AR) device,
wherein the information about the second object is output using AR.

4. The method of claim 3, wherein the AR device is AR glasses or an AR mobile terminal.

5. The method of claim 1, wherein estimating the position of the object comprises:
detecting a fingertip of the user according to the first indicative gesture; and
determining 3D coordinates corresponding to the fingertip of the user and estimating the position of the object using the 3D coordinates.

6. The method of claim 5, wherein the first indicative gesture is recognized through a camera, and the 3D coordinates are determined using a coordinate system of the camera, the left coordinate system, and the right coordinate system.

7. The method of claim 6, wherein the 3D coordinates are determined using distances and angles between the camera and each of the left eye of the user and the right eye of the user.

8. An augmented reality device comprising:
a transceiver for transmitting and receiving wireless signals;
a sensor; and
a processor configured to:
sense a first indicative gesture of a user via the sensor;
estimate a position of an object that is indicated by the first indicative gesture;
determine whether the estimated position of the corresponds to a left coordinate system or a right coordinate system;
calculate a score for each of the left coordinate system and the right coordinate system, wherein the score for the left coordinate system is increased when it is determined that the estimated position of the object corresponds to the left coordinate system and the score for the right coordinate system is increased when it is determined that the estimated position of the object corresponds to the right coordinate system; and
determine a main eyesight of the user based on the calculated scores,
wherein the left coordinate system is related to a gaze by the left eye of the user and the right coordinate system is related to gaze by the right eye of the user.

9. The augmented reality device of claim 8, wherein:
the main eyesight of the user is determined as the left eye of the user when the score for the left coordinate system is greater than the score for the right coordinate system; and
the main eyesight of the user is determined as the right eye of the user when the score for the right coordinate system is greater than the score for the left coordinate system.

10. The augmented reality device of claim 8, wherein the processor is further configured to:
sense a second object at a position that is indicated by a second indicative gesture of the user sensed via the sensor based on the main eyesight; and
output information about the second object using augmented reality (AR).

11. The augmented reality device of claim 10, wherein the AR device is AR glasses or an AR mobile terminal.

12. The augmented reality device of claim 8, wherein the processor is further configured to estimate the position of the object by:
detecting a fingertip of the user according to the first indicative gesture; and
determining 3D coordinates corresponding to the fingertip of the user, and estimates the position of the object using the 3D coordinates.

13. The augmented reality device of claim 12, wherein the sensor is a camera and the 3D coordinates are determined using a coordinate system of the camera, the left coordinate system, and the right coordinate system.

14. The augmented reality device of claim 13, wherein the 3D coordinates are determined using distances and angles between the camera and each of the left eye of the user and the right eye of the user.

15. A machine-readable non-transitory medium having stored thereon machine-executable instructions for gesture recognition calibration of an augmented reality device, the instructions comprising:
estimating a position of an object that is indicated by a first indicative gesture of a user;
determining whether the estimated position of the object corresponds to a left coordinate system or a right coordinate system;
calculating a score for each of the left coordinate system and the right coordinate system, wherein the score for the left coordinate system is increased when it is determined that the estimated position of the object corresponds to the left coordinate system and the score for the right coordinate system is increased when it is determined that the estimated position of the object corresponds to the right coordinate system; and
determining a main eyesight of the user based on the calculated scores,
wherein the left coordinate system is related to a gaze by the left eye of the user and the right coordinate system is related to gaze by the right eye of the user.
